(19) United States
(12) Patent Application Publication
(10) Pub. No.: US 2008/0118056 A1
(43) Pub. Date: May 22, 2008

(54) Telematics device with TDD ability

(76) Inventors: Robert W. Hjelmeland, Kempton (IN); John F. King, Noblesville, IN (US)

Correspondence Address: DELPHI TECHNOLOGIES, INC., M/C 480-410-202, PO BOX 5052, TROY, MI, 48007, US

(21) Appl. No.: 11/600,644

(22) Filed: Nov. 16, 2006

(51) Int. Cl. H04M 1/00

(52) U.S. Cl. 379/420.01

(57) ABSTRACT

A telematics device (10) for an automotive vehicle has an interface capability with a TDD (36) to provide abilities to transmit and receive TDD data only calls, Voice Carry Over calls and Hearing Carry Over calls.

### TECHNICAL FIELD

This invention relates to a telematics system for an automotive vehicle having TDD ability.

### BACKGROUND OF THE INVENTION

Telematics devices are becoming very popular in automotive vehicles. Telematic devices provide hands-free cellular telephonic communication, global positioning, directions to destinations and emergency services in case of a vehicular accident or medical emergency. These devices are capable of detecting a crash and automatically placing a call to a remote response center staffed around the clock by personnel who may speak to the occupants and alert the appropriate local authorities for prompt responsive services.

All presently commercially available telematics devices in automotive vehicles do not accommodate people with hearing difficulties or major speech impairments. Deaf people or people with speech impairments have been able to use cell phones and land line phones with the use of commercially available telecommunication devices for the deaf (TDDs). However, no TDD has been interfaced with an automotive telematics device. The concept of a removable portable teletype unit to be used by sound impaired people that is removably connected to an embedded in-vehicle telematics system is disclosed in U.S. Pat. No. 6,983,171.

What is needed is a telematics device for an automotive vehicle properly modified to interface with a TDD and a method of easily modifying existing telematics devices such that TDD communication including Voice Carry Over, Hearing Carry Over and solely TDD communication modes is available in a telematics system for an automotive vehicle.

### SUMMARY OF THE INVENTION

According to one aspect of the invention, a telematics device for an automotive vehicle provides global positioning and hands free cellular telephone calls. A telecommunication device for the deaf interfaces with the telematics device for providing TDD data only calls, Voice Carry Over calls and Hearing Carry Over calls. The telematics device has a micro-controller and a multiplexer and audio speaker amplifier connected to an audio speaker. The micro-controller is operably connected to the multiplexer for configuring the multiplexer to cut out white noise to the audio speaker amplifier and the audio speaker on TDD only calls and Voice Carry Over calls.

Preferably, a digital signal processor in the telematics device is constructed to detect an incoming Baudot signal from a cellular telephone call and connected to the micro-controller to configure the telematics device to pass the incoming Baudot signal to the telecommunication device for the deaf via a buffer. The telematics device desirably has a Hearing Carry Over mode whereby the telematics device provides incoming communication to the audio speaker to receive a telephone call as normal. The telematic device when in the Hearing Carry Over mode detects the presence of an outgoing TDD transmission from the telecommunication device for the deaf for transmission.

The audio speaker is preferably constructed to receive ring tones and a busy tone. The telecommunication device for the deaf is constructed to present ringing or busy messages.

In one embodiment, the telematic device has a collision detection system that initiates an outgoing call to a remote response center and the remote response center communicates with a vehicle occupant through the telecommunication device for the deaf in a predetermined TDD only, Voice Carry Over, or Hearing Carry Over mode.

Preferably, the telematics device has a Voice Carry Over mode whereby the telematics device provides the outgoing communication inputted from the telematics microphone to send a telephone voice signal as normal. The telematic device when in the Voice Carry Over mode detects the incoming signals and sends them to the telecommunication device for the deaf for a visual display.

According to another aspect of the invention, a telematics device for an automotive vehicle interfaces with a TDD and has a TDD data only mode, Voice Carry Over mode and Hearing Carry Over mode. A comparator circuit presents a signal to a micro-controller based on the presence of a TDD. The micro-controller is constructed to configure a first multiplexer based on the incoming signal from the comparator circuit. The first multiplexer is able to detect the presence of the TDD and whether it is in a TDD only mode, Voice Carry Over mode, or a Hearing Carry Over mode from the comparator circuit to enable a microphone to pass voice information to a digitizer to transmit voice over an embedded cell phone during a Voice Carry Over mode. The micro-controller is also constructed to configure a second multiplexer to cut out white noise to an operably connected audio speaker amplifier and audio speaker when the TDD is in a TDD only mode or Voice Carry Over mode.

### BRIEF DESCRIPTION OF THE DRAWINGS

The present invention will now be described, by way of example, with reference to the accompanying drawing, in which:

FIG. 1 is a schematic diagram of one embodiment according to the invention.

### DESCRIPTION OF THE PREFERRED EMBODIMENT

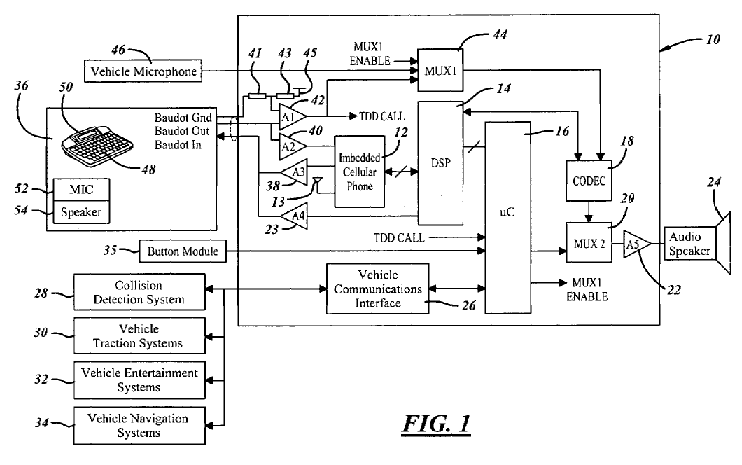

Referring now to FIG. 1, a vehicle telematics device has an imbedded cellular phone 12 with an antenna 13. The phone is operably connected to a digital signal processor (DSP) 14 which in turn is operably connected to a micro-controller (uC) 16 through a multi pin communication cable or similarly capable interconnect. The DSP 14 is also operably connected to a coder/decoder (CODEC) device 18. The CODEC 18 and microcontroller 16 are both connected to a second multiplexer 20 which leads to a amplifier (A5) 22 which leads to the vehicle speaker or audio system 24. The DSP 14 is also connected to an input of an amplifier (A4) 23.

The microcontroller 16 is also connected to a vehicle communications interface 26 which may be connected to various accessories such as a collision detection system 28, a vehicle traction system 30, a vehicle entertainment system 32 or a vehicle navigation system 34. A button module 35 often found on “On-Star” systems includes an ON STAR call button, an “emergency” button and a “voice recognition” button often called the “dot” button due to the dot on the button. The button module 35 is operably connected to the microcontroller 16.

The telematics device in order to accommodate a telecommunications device for the deaf (TDD) 36 has a buffer (A3) 38 for sending an incoming Baudot signal to the TDD device 36 from the cell phone 12, an amplifier (A2) 40 for sending an outgoing Baudot signal from the TDD 36 to the cell phone 12. A circuit comparator (Al) 42 also is connected to the microcontroller such that the microcontroller 16 through the comparator circuit 42 can detect when TDD 36 is connected and active to with an outgoing Baudot signal. The comparator 42 has a circuit connected to a resistor 41 between the TDD 36 and the comparator 42 and a second resistor 43 between the comparator 42 and ground 45.

The microcontroller 16 configures the cellular phone 12, the DSP 14 and a multiplexor (MUX 1) 44 for TDD communications once the presence of a TDD 36 is sensed by the comparator 42. The multiplexer can then receive the outgoing signal from the comparator 42. The multiplexer 44 is connected to the CODEC device 18.

A vehicle microphone 46 is also connected to the telematics device 10 into the multiplexer 44 for, when desired, normal outgoing voice communication.

A typical TDD 36 has a keyboard 48, a visual display 50 and a built-in microphone 52 and speaker 54. The TDD 36 is also connected to the DSP 14 through the output end of amplifier 23 so that the DSP 14 can configure the TDD for system enhancements.

With the above described circuit, the TDD device 36 can be fully implemented in three modes, a TDD only mode, a Voice Carry Over mode and a Hearing Carry Over mode.

Initiation of a TDD data only call is commenced by the phone number being entered using the TDD keyboard 48 and pressing of a “dial” or “send” key. The imbedded phone receives the proper information via the Baudot protocol through the amplified 40 and also through the circuit comparator 42, the multiplexor 44, the CODEC 18, the DSP 14 and microcontroller 16.

The imbedded phone 12 then places the call. The phone and TDD communicate status information such as “ringing” or “busy” signals via the same Baudot protocol.

In a TDD only mode, when the TDD 36 produces Baudot based data, it is passed to the telematics device via amplifier 40 and comparator 42. The microcontroller configures the multiplexor 20 to insure that no undesirable white noise is presented to the vehicle speakers 24 through the amplifier 22. Incoming TDD information is received from the cellular phone and passed through buffer 38 to the TDD 36.

If a TDD data only call is received by the cell phone, the DSP 14 detects the incoming Baudot signal and communicates with the mircrocontroller 16 which configures the telematics device to pass the incoming information to the TDD via the buffer 38. Outgoing TDD information is then handled that same as placing a TDD data only call.

If the TDD device is in a Hearing Carry Over mode, the embedded cell phone receives a call as normal and sends the audio signal to the audio system speaker 24. Outgoing communication however is keyed into the TDD device as previously described.

An outgoing Hearing Carry Over call is initiated in the same fashion as a TDD only call. Once it is initiated, the incoming information is received by the imbedded cell phone and can be heard through the audio system at speaker 24. System status signals such as ring tones and busy signals can also be directed to the audio system. The TDD 36 can simultaneously be used to display a ringing or busy message.

If the TDD device is in a Voice Carry Over mode, an outgoing voice carry over phone call can be initiated in the same way as a normal phone call. The vehicle microphone 46 is enabled through the multiplexor 44 and allows the voice information to be presented to the CODEC 18 which passes the now digital information to the DSP 14 which configures it for transmission by the phone. The phone transmits the outgoing voice signal as normal.

Incoming information in a Voice Carry Over mode is received by the imbedded cell phone and passed to the TDD 36 via the buffer amplifier 38 for display on the display 50. The multiplexor 20 is configured to cut out the white noise to the speaker 24 in the same fashion as with TDD data only calls.

For receiving a Voice Carry Over call, the imbedded cellular telephone detects the incoming call and configures the telematics system for proper reception. The telematics system detects the Baudot code for Voice Carry Over from the TDD and configures itself accordingly. The microprocessor configures the multiplexor 44 to allow the microphone output to be sent to the CODEC 18, DSP 14 and the cellular phone 12. The incoming information is then presented to the TDD 36 through the buffer 38. The multiplexer 20 is similarly configured to cut out the white noise to the amplifier 22 and speaker 24.

In this fashion, a telematics system for an automotive vehicle can be modified to create the ability to receive and send TDD calls whether they are TDD data only calls, Voice Carry Over calls, or Hearing Carry Over calls. Secondly, the telematics system can incorporate the TDD 36 for use with the button module 35 and for use in responses and inquiries made during activation of the collision detection system 28.

In other words, it will be readily understood by those persons skilled in the art that the present invention is susceptible of broad utility and application. Many embodiments and adaptations of the present invention other than those described above, as well as many variations, modifications and equivalent arrangements, will be apparent from or reasonably suggested by the present invention and the foregoing description, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements, the present invention being limited only by the following claims and the equivalents thereof.

We claim

1. A telematics device for an automotive vehicle comprising:
a vehicle telematics device for providing global positioning and hands free cellular telephone calls;
a telecommunication device for the deaf interfacing with the telematics device for providing TDD data only calls, Voice Carry Over calls and Hearing Carry Over calls on said telematics device
said telematics device having a micro-controller and a multiplexer and audio speaker amplifier connected to an audio speaker; and
said micro-controller operably connected to said multiplexer for configuring said multiplexer to cut out white noise to said audio speaker amplifier and said audio speaker on TDD only calls and Voice Carry Over calls.

2. A telematics device as defined in claim 1 further comprising:
a digital signal processor in said telematics device being constructed to detect an incoming Baudot signal from a cellular telephone call and connected to the micro-controller to configure the telematics device to pass the incoming Baudot signal to the telecommunication device for the deaf via a buffer.

3. A telematics device as defined in claim 1 further comprising:
said telematics device having a Hearing Carry Over mode whereby said telematics device provides incoming communication presented to the audio speaker to receive a telephone call as normal; and
said telematic device when in the Hearing Carry Over mode detects the presence of an outgoing TDD transmission from said telecommunication device for the deaf for transmission.

4. A telematics device as defined in claim 3 further comprising:
said audio speaker constructed to receive ring tones, a busy tone; and
said telecommunication device for the deaf constructed to present ringing or busy messages.

5. A telematics device as defined in claim 2 further comprising:
said telecommunication device for the deaf constructed to present a ringing or a busy message.

6. A telematic device as defined in claim 3 further comprising:
said telecommunication device for the deaf constructed to present a ringing or a busy message.

7. A telematic device as defined in claim 1 further comprising:
a collision detection system operably connected to said vehicle telematics system that initiates an outgoing call to a remote response center and the remote response center communicates with a vehicle occupant through said telecommunication device for the deaf in a predetermined TDD only, Voice Carry Over or Hearing Carry Over mode.

8. A telematics system as defined in claim 1 further comprising:
said telematics device having its Voice Carry Over mode whereby said telematics device provides said outgoing communication imputed from said telematics microphone to send a telephone voice signal as normal;
said telematic device when in Voice Carry Over mode detects the incoming signals and sends them to the telecommunication device for the deaf for a visual display.

9. A telematic device for an automotive vehicle comprising:
a TDD interfacing with said telematics device and having a TDD data only mode, Voice Carry Over mode or Hearing Carry Over mode;
a comparator circuit that presents a signal to a micro-controller based on the presence of said TDD;
said micro-controller constructed to configure a first multiplexer based on said incoming signal from said comparator circuit; said first multiplexer being able to detect the presence of said TDD and whether it's in a TDD only mode, Voice Carry Over mode, or a Hearing Carry Over mode from said comparator circuit to enable a microphone to pass voice information to a digitizer to transmit said voice over an embedded cell phone during a Voice Carry Over mode; and
said micro-controller constructed to configure a second multiplexer to cut out white noise to an operably connected audio speaker amplifier and audio speaker when said TDD is in a TDD data only mode or Voice Carry Over mode.
